(19) United States
(12) Patent Application Publication
(10) Pub. No.: US 2026/0106553 A1
(43) Pub. Date: Apr. 16, 2026

(54) LOAD-DEPENDENT CONTROL OF A DUAL ACTIVE BRIDGE WITH A DUTY CYCLE MODE

(71) Applicant: Schneider Electric IT Corporation, Foxboro, MA (US)

(72) Inventors: Pin Chieh Chan, Taipei City (TW); Wei TI Kang, Taipei City (TW); Ko Li Pai, Taipei City (TW); Kuo Liang Lee, Taipei City (TW)

(73) Assignee: Schneider Electric IT Corporation, Foxboro, MA (US)

(21) Appl. No.: 19/358,799

(22) Filed: Oct. 15, 2025

Related U.S. Application Data
(60) Provisional application No. 63/707,781, filed on Oct. 16, 2024.

(51) Int. Cl. H02M 3/335; H02J 7/00; H02J 9/06

(52) U.S. Cl. CPC H02M 3/33573; H02J 7/855; H02J 7/933; H02J 9/062; H02M 3/33576; H02J 2207/20

(57) ABSTRACT

The techniques described herein relate to load-dependent control of a dual active bridge with a duty cycle mode. An example battery discharge system includes a first H-bridge configured to be coupled to a battery, the first H-bridge including a first plurality of switches, a second H-bridge configured to be coupled to a load, the second H-bridge including a second plurality of switches, a transformer coupled to the first H-bridge and the second H-bridge, and at least one controller. The at least one controller is configured to receive a signal indicating that a power demand of the load is below a threshold load, and in response to receiving the signal, generate control signals to operate the system in a duty cycle mode in which the first plurality of switches is pulse-modulated with a duty cycle overlap adjusted based on the power demand, and the second plurality of switches is kept open.

### RELATED APPLICATION

This application claims priority under 35 U.S.C. § 119 to U.S. Provisional Application No. 63/707,781, filed on Oct. 16, 2024, which is herein incorporated by reference in its entirety.

### FIELD

The techniques described herein relate generally to circuits and, more particularly, to load-dependent control of a dual active bridge with a duty cycle mode.

### BACKGROUND

Power devices, such as uninterruptible power supplies (UPSs), may be used to provide regulated, uninterrupted power for sensitive and/or critical loads, such as computer systems and other data-processing systems. Examples of UPSs include online UPSs, offline UPSs, line-interactive UPSs, as well as others. UPSs may provide output power to a load. The output power may be derived from a primary source of power, such as a utility-mains source, and/or derived from a backup source of power, such as an energy-storage device.

### SUMMARY

At least one example in accordance with the present disclosure relates generally to a dual active bridge (DAB) converter.

According to at least one aspect of the present disclosure, a battery discharge system is disclosed. The battery discharge system includes a first H-bridge configured to be coupled to a battery, the first H-bridge including a first plurality of switches; a second H-bridge configured to be coupled to a load, the second H-bridge including a second plurality of switches; a transformer coupled to the first H-bridge and the second H-bridge; and at least one controller configured to receive a signal indicating that a power demand of the load is below a threshold load, and in response to receiving the signal, generate control signals to operate the system in a duty cycle mode in which the first plurality of switches is pulse-modulated with a duty cycle overlap adjusted based on the power demand, and the second plurality of switches is kept open.

According to another aspect of the present disclosure, a method of controlling a battery discharge system including a first H-bridge configured to be coupled to a battery, the first H-bridge including a first plurality of switches, a second H-bridge configured to be coupled to a load, the second H-bridge including a second plurality of switches, and a transformer coupled to the first H-bridge and the second H-bridge is disclosed. The method includes receiving a signal indicating that a power demand of the load is below a threshold load; and in response to receiving the signal, operating the system in a duty cycle mode in which the first plurality of switches is pulse-modulated with a duty cycle overlap adjusted based on the power demand, and the second plurality of switches is kept open.

According to another aspect of the present disclosure, at least one non-transitory computer-readable medium storing thereon sequences of computer-executable instructions for controlling a battery discharge system including a first H-bridge configured to be coupled to a battery, the first H-bridge including a first plurality of switches, a second H-bridge configured to be coupled to a load, the second H-bridge including a second plurality of switches, and a transformer coupled to the first H-bridge and the second H-bridge is disclosed. The sequences of computer-executable instructions include instructions that instruct at least one processor to receive a signal indicating that a power demand of the load is below a threshold load; and in response to receiving the signal, operate the system in a duty cycle mode in which the first plurality of switches is pulse-modulated with a duty cycle overlap adjusted based on the power demand, and the second plurality of switches is kept open.

The foregoing summary is not intended to be limiting. Moreover, various aspects of the present disclosure may be implemented alone or in combination with other aspects.

### BRIEF DESCRIPTION OF FIGURES

Various aspects of at least one embodiment are discussed below with reference to the accompanying figures, which may not be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain the principles and operations of the described and claimed aspects and embodiments. In the figures, each identical or substantially similar component that is illustrated in various figures may be represented by a like numeral. For purposes of clarity, not every component may be labeled in every figure.

FIG. 1 illustrates a block diagram of a UPS including a dual active bridge (DAB) converter according to an example.

FIG. 2 illustrates a circuit diagram of a DAB converter according to an example.

FIGS. 3A and 3B illustrate circuit diagrams of a DAB converter in a pulse-width modulation (PWM) mode of operation during positive and negative intervals, respectively, according to an example.

FIG. 4 illustrates a positive-interval diagram of the operation of a DAB converter under a PWM control scheme during a pre-charge stage according to an example.

FIG. 5 illustrates a diagram of a duty cycle mode of operation of a DAB converter with increasing overlapping periods during the pre-charge stage according to an example.

FIG. 6 illustrates a PWM control diagram including a duty cycle mode followed by a shift angle mode to operate a DAB converter according to an example.

FIG. 7 illustrates a diagram of a load-dependent control scheme of a DAB converter including a duty cycle mode and a shift angle mode according to an example.

FIG. 8 illustrates a process to execute the control scheme of FIG. 7 including the duty cycle mode and the shift angle mode in response to external load variations according to an example.

FIGS. 9A and 9B illustrate circuit diagrams experiencing reverse current spikes generated on a secondary side of a DAB converter immediately after overlapping periods according to an example.

FIG. 10 illustrates a diagram of secondary-side phase shifts between control signals to the left switches and the control signals to the right switches in the shift angle mode according to an example.

FIGS. 11A and 11B illustrate circuit diagrams of the implementation of the secondary-side phase shifts in the shift angle mode to avoid secondary-side reverse current spikes.

FIGS. 12A and 12B illustrate the operation of a shift angle mode of the DAB converter including implementing secondary-side phase shifts between the secondary-side left switches and the corresponding secondary-side right switches to avoid secondary-side reverse current spikes according to an example.

### DETAILED DESCRIPTION

As discussed above, an uninterruptible power supply (UPS) may be used to provide regulated, uninterruptible power to one or more loads at an output of the UPS. An example UPS may include at least two inputs. A first input is configured to be coupled to a primary power source (including, for example, a utility mains supply) and a second input is configured to be coupled to a secondary power source (including, for example, one or more energy-storage devices, such as batteries). If acceptable power is available from the primary power source, the UPS may draw power from the primary power source along a first power path from the first input to the output. If acceptable power is not available from the primary power source, the UPS may draw power from the secondary power source along a second power path from the second input to the output.

The first and second power paths may each include one or more converters, such as AC/DC converters, DC/AC converters, and/or DC/DC converters. In some examples UPSs, the first power path may extend from the first input to the output through an AC/DC converter, a DC bus, and a DC/AC converter, and the second power path may extend from the second input to the output through a DC/DC converter, the DC bus, and the DC/AC converter. In various examples, the DC/DC converter may be a dual-active-bridge (DAB) converter.

In these examples, the DAB converter may be controlled by manipulating the switches of the DAB based on a pulse-width modulation (PWM) scheme. In certain examples of the PWM scheme, the power drawn through the DAB converter may be controlled by adjusting (for example, increasing or decreasing) a phase shift angle between pulses of various DAB switches, which may be referred to as shift angle control. In some examples, the shift angle control may allow the DAB converter to adjust the energy-storage-device discharge power according to a change in the load of the UPS.

However, the shift angle control scheme may not prevent the generation of a detrimental inrush current in the DAB converter in an initial pre-charge phase of the DAB operation when the load is usually light. For example, when the UPS switches from the first power path to the second power path, a DAB converter under shift angle control may turn on all the switches together in the pre-charge phase so that the battery-discharge power drawn through the DAB converter may suddenly increase from substantially zero to a level balanced by the light load as quickly as possible. This quick increase in power may cause a significant inrush current to flow through various circuit elements of the DAB converter due to the inductive reactance of the DAB converter (including a transformer and inductors) and damage those circuit elements.

To avoid generating a significant inrush current in the pre-charge stage, a pre-charge circuit may be implemented to pre-charge the DAB converter more gradually. In one example, a pre-charge circuit may significantly lower the energy-storage-device discharge voltage or power to decrease the inrush current in the DAB converter. However, lowering the discharge voltage or power may result in an undesirably long pre-charge time.

In another example, a pre-charge circuit may be added to rectify the AC mains power to DC power for pre-charging the DAB converter. However, the rectified voltage or power may also have a low peak value, resulting in an undesirably long pre-charge time. Adding a pre-charge circuit also increases the total cost of the UPS.

Examples of the disclosure include a solution for pre-charging a DAB converter without a separate, dedicated pre-charging circuit. Examples of the disclosure combine a shift angle mode with a duty cycle mode capable of quickly pre-charging the DAB converter without inducing a significant inrush current or requiring a pre-charge circuit. Furthermore, examples of the disclosure reduce spike currents and/or reverse currents in the DAB converter. Accordingly, examples of the disclosure enable the pre-charging of a DAB converter without causing a significant inrush current.

According to at least one aspect of the present disclosure, a battery discharge system is disclosed. The battery discharge system includes a first H-bridge configured to be coupled to a battery, the first H-bridge including a first plurality of switches; a second H-bridge configured to be coupled to a load, the second H-bridge including a second plurality of switches; a transformer coupled to the first H-bridge and the second H-bridge; and at least one controller configured to receive a signal indicating that a power demand of the load is below a threshold load, and in response to receiving the signal, generate control signals to operate the system in a duty cycle mode in which the first plurality of switches is pulse-modulated with a duty cycle overlap adjusted based on the power demand, and the second plurality of switches is kept open.

In one example of the battery discharge system, the first plurality of switches includes a first half of switches and a second half of switches; and the duty cycle overlap is between a duty cycle of the first half of switches and a duty cycle of the second half of switches.

In another example of the battery discharge system, the at least one controller is further configured to receive a second signal indicating that a second power demand of the load is above the threshold load; and in response to receiving the second signal, generate control signals to operate the system in a shift angle mode in which the first plurality of switches and the second plurality of switches are pulse-modulated, and a phase shift angle between pulses of the first plurality of switches and pulses of the second plurality of switches is adjusted based on the second power demand. In one example of the battery discharge in system, the phase shift angle is between a first duty cycle overlap of the pulses of the first plurality of switches and a second duty cycle overlap of the pulses of the second plurality of switches. In another example of the battery discharge system, the first H-bridge includes a first half of switches and a second half of switches; and operating the system in the shift angle mode includes adjusting a second phase shift angle between pulses of the first half of switches and pulses of the second half of switches based on a battery voltage. In one example of the battery discharge system, adjusting the second phase shift angle between the pulses of the first half of switches and the pulses of the second half of switches based on the battery voltage includes adjusting the second phase shift angle based on a linear relationship between the second phase shift angle and the battery voltage. In another example of the battery discharge system, operating the system in the shift angle mode includes setting the duty cycle overlap at substantially 50%.

According to another aspect of the present disclosure, a method of controlling a battery discharge system including a first H-bridge configured to be coupled to a battery, the first H-bridge including a first plurality of switches, a second H-bridge configured to be coupled to a load, the second H-bridge including a second plurality of switches, and a transformer coupled to the first H-bridge and the second H-bridge is disclosed. The method includes receiving a signal indicating that a power demand of the load is below a threshold load; and in response to receiving the signal, operating the system in a duty cycle mode in which the first plurality of switches is pulse-modulated with a duty cycle overlap adjusted based on the power demand, and the second plurality of switches is kept open.

In one example of the method, the first plurality of switches includes a first half of switches and a second half of switches; and the duty cycle overlap is between a duty cycle of the first half of switches and a duty cycle of the second half of switches.

In another example, the method further includes receiving a second signal indicating that a second power demand of the load is above the threshold load; and in response to receiving the second signal, operating the system in a shift angle mode in which the first plurality of switches and the second plurality of switches are pulse-modulated, and a phase shift angle between pulses of the first plurality of switches and pulses of the second plurality of switches is adjusted based on the second power demand. In one example of the method, the phase shift angle is between a first duty cycle overlap of the pulses of the first plurality of switches and a second duty cycle overlap of the pulses of the second plurality of switches. In some examples of the method, the first H-bridge includes a first half of switches and a second half of switches; and operating the system in the shift angle mode includes adjusting a second phase shift angle between pulses of the first half of switches and pulses of the second half of switches based on a battery voltage. In one example of the method, adjusting the second phase shift angle between the pulses of the first half of switches and the pulses of the second half of switches based on the battery voltage includes adjusting the second phase shift angle based on a linear relationship between the second phase shift angle and the battery voltage. In various examples of the method, operating the system in the shift angle mode includes setting the duty cycle overlap at substantially 50%.

According to another aspect of the present disclosure, at least one non-transitory computer-readable medium storing thereon sequences of computer-executable instructions for controlling a battery discharge system including a first H-bridge configured to be coupled to a battery, the first H-bridge including a first plurality of switches, a second H-bridge configured to be coupled to a load, the second H-bridge including a second plurality of switches, and a transformer coupled to the first H-bridge and the second H-bridge is disclosed. The sequences of computer-executable instructions include instructions that instruct at least one processor to receive a signal indicating that a power demand of the load is below a threshold load; and in response to receiving the signal, operate the system in a duty cycle mode in which the first plurality of switches is pulse-modulated with a duty cycle overlap adjusted based on the power demand, and the second plurality of switches is kept open.

In one example of the at least one non-transitory computer-readable medium, the first plurality of switches includes a first half of switches and a second half of switches; and the duty cycle overlap is between a duty cycle of the first half of switches and a duty cycle of the second half of switches.

In another example of the at least one non-transitory computer-readable medium, the instructions further instruct the at least one processor to receive a second signal indicating that a second power demand of the load is above the threshold load; and in response to receiving the second signal, operate the system in a shift angle mode in which the first plurality of switches and the second plurality of switches are pulse-modulated, and a phase shift angle between pulses of the first plurality of switches and pulses of the second plurality of switches is adjusted based on the second power demand. In some examples of the at least one non-transitory computer-readable medium, the phase shift angle is between a first duty cycle overlap of the pulses of the first plurality of switches and a second duty cycle overlap of the pulses of the second plurality of switches. In one example of the at least one non-transitory computer-readable medium, the first H-bridge includes a first half of switches and a second half of switches; and operating the system in the shift angle mode includes adjusting a second phase shift angle between pulses of the first half of switches and pulses of the second half of switches based on a battery voltage. In certain examples of the at least one non-transitory computer-readable medium, adjusting the second phase shift angle between the pulses of the first half of switches and the pulses of the second half of switches based on the battery voltage includes adjusting the second phase shift angle based on a linear relationship between the second phase shift angle and the battery voltage.

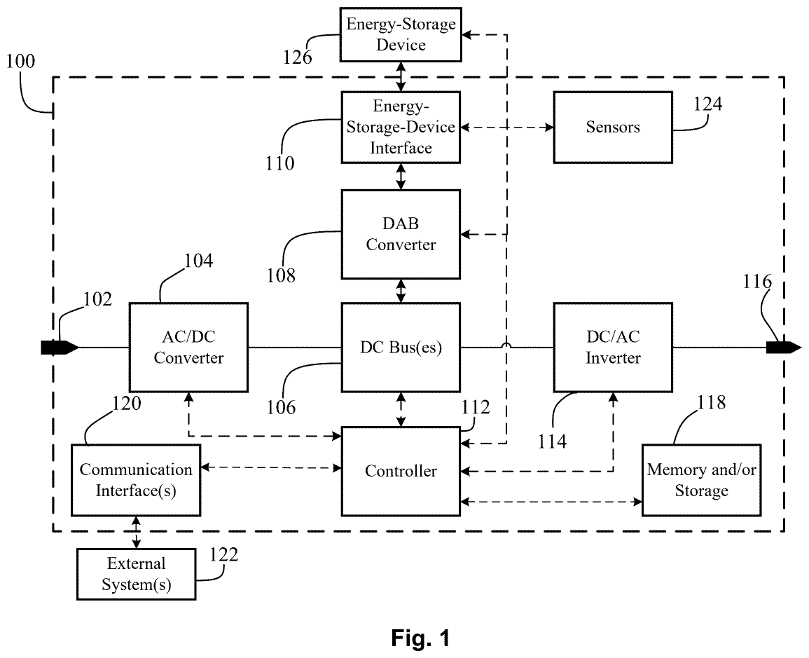

FIG. 1 illustrates a block diagram of a UPS 100 including a DAB converter 108 according to an example. The UPS 100 includes an input 102, an AC/DC converter 104, one or more DC buses 106, the DAB converter 108, an energy-storage-device interface 110, at least one controller 112 (“controller 112”), a DC/AC inverter 114, an output 116, a memory and/or storage 118, one or more communication interfaces 120 (“communication interfaces 120”), which may be communicatively coupled to one or more external systems 122 (“external systems 122”), and one or more sensors 124 (“sensors 124”), which may include sensors such as voltage sensors, current sensors, temperature sensors, and/or other sensors.

The input 102 is configured to be coupled to the AC/DC converter 104 and to an AC power source (not illustrated), such as an AC mains power supply. The AC/DC converter 104 is coupled to the input 102 and to the one or more DC buses 106, and is communicatively coupled to the controller 112. The one or more DC buses 106 are coupled to the AC/DC converter 104, the DAB converter 108, and to the DC/AC inverter 114. The DAB converter 108 is coupled to the one or more DC buses 106 and to the energy-storage-device interface 110, and is communicatively coupled to the controller 112. The energy-storage-device interface 110 is coupled to the DAB converter 108, and is configured to be coupled to at least one energy-storage device 126 and/or another energy-storage device. In some examples, the energy-storage-device interface 110 is configured to be communicatively coupled to the controller 112.

In some examples, the UPS 100 may be external to the at least one energy-storage device 126 and may be coupled to the at least one energy-storage device 126 via the energy-storage-device interface 110. In various examples, the UPS 100 may include one or more energy-storage devices, which may include the at least one energy-storage device 126. The at least one energy-storage device 126 may include one or more batteries, capacitors, flywheels, or other energy-storage devices in various examples.

The DC/AC inverter 114 is coupled to the one or more DC buses 106 and to the output 116, and is communicatively coupled to the controller 112. The output 116 is coupled to the DC/AC inverter 114, and is configured to be coupled to an external load (not illustrated). The controller 112 is communicatively coupled to the AC/DC converter 104, the one or more DC buses 106, the DAB converter 108, the energy-storage-device interface 110, the DC/AC inverter 114, the memory and/or storage 118, the communication interfaces 120, and/or the at least one energy-storage device 126. The sensors 124 are communicatively coupled to the controller 112 and may be coupled to one or more other components of the UPS 100, such as the input 102, the AC/DC converter 104, the one or more DC buses 106, the DAB converter 108, the energy-storage-device interface 110, the DC/AC inverter 114, and/or the output 116.

The input 102 is configured to be coupled to an AC mains power source and to receive input AC power having an input voltage level. The UPS 100 is configured to operate in different modes of operation based on the input voltage of the AC power provided to the input 102. The controller 112 may determine a mode of operation in which to operate the UPS 100 based on whether the input voltage of the AC power is acceptable. The controller 112 may include or be coupled to one or more sensors, such as the sensors 124, configured to sense parameters of the input voltage. For example, the sensors 124 may include one or more voltage and/or current sensors coupled to the input 102 and being configured to sense information indicative of a voltage at the input 102 and provide the sensed information to the controller 112.

When AC power provided to the input 102 is acceptable (for example, by having parameters, such as an input voltage value, that meet specified values, such as by falling within a range of acceptable input voltage values), the controller 112 controls components of the UPS 100 to operate in a normal mode of operation. In the normal mode of operation, AC power received at the input 102 is provided to the AC/DC converter 104. The AC/DC converter 104 converts the AC power into DC power and provides the DC power to the one or more DC buses 106. The one or more DC buses 106 distribute the DC power to the DAB converter 108 and to the DC/AC inverter 114. The DAB converter 108 converts the received DC power and provides the converted DC power to the energy-storage-device interface 110. The energy-storage-device interface 110 receives the converted DC power, and provides the converted DC power to the at least one energy-storage device 126 to charge the at least one energy-storage device 126. The DC/AC inverter 114 receives DC power from the one or more DC buses 106, converts the DC power into regulated AC power, and provides the regulated AC power to the output 116 to be delivered to a load.

When AC power provided to the input 102 from the AC mains power source is not acceptable (for example, by having parameters, such as an input voltage value, that do not meet specified values, such as by falling outside of a range of acceptable input voltage values), the controller 112 controls components of the UPS 100 to operate in a backup mode of operation. In the backup mode of operation, DC power is discharged from the at least one energy-storage device 126 to the energy-storage-device interface 110, and the energy-storage-device interface 110 provides the discharged DC power to the DAB converter 108. The DAB converter 108 converts the received DC power and distributes the DC power amongst the one or more DC buses 106. For example, the DAB converter 108 may evenly distribute the power amongst the one or more DC buses 106. The one or more DC buses 106 provide the received power to the DC/AC inverter 114. The DC/AC inverter 114 receives the DC power from the one or more DC buses 106, converts the DC power into regulated AC power, and provides the regulated AC power to the output 116.

In some examples, the sensors 124 may include one or more sensors coupled to one or more of the components of the UPS 100 such that a voltage and/or current of one or more of the components may be determined by the controller 112. The controller 112 may store information in, and/or retrieve information from, the memory and/or storage 118. For example, the controller 112 may store information indicative of sensed parameters (for example, input-voltage values of the AC power received at the input 102) in the memory and/or storage 118. The controller 112 may further receive information from, or provide information to, the communication interfaces 120. The communication interfaces 120 may include one or more communication interfaces including, for example, user interfaces (such as display screens, touch-sensitive screens, keyboards, mice, trackpads, dials, buttons, switches, sliders, light-emitting components such as light-emitting diodes, sound-emitting components such as speakers, buzzers, and so forth configured to output sound inside and/or outside of a frequency range audible to humans, and so forth), wired communication interfaces (such as wired ports), wireless communication interfaces (such as antennas), and so forth, configured to exchange information with one or more systems, such as the external systems 122, or other entities, such as human beings. The external systems 122 may include any device, component, module, and so forth, that is external to the UPS 100, such as a server, database, laptop computer, desktop computer, tablet computer, smartphone, central controller or data-aggregation system, other UPSs, and so forth.

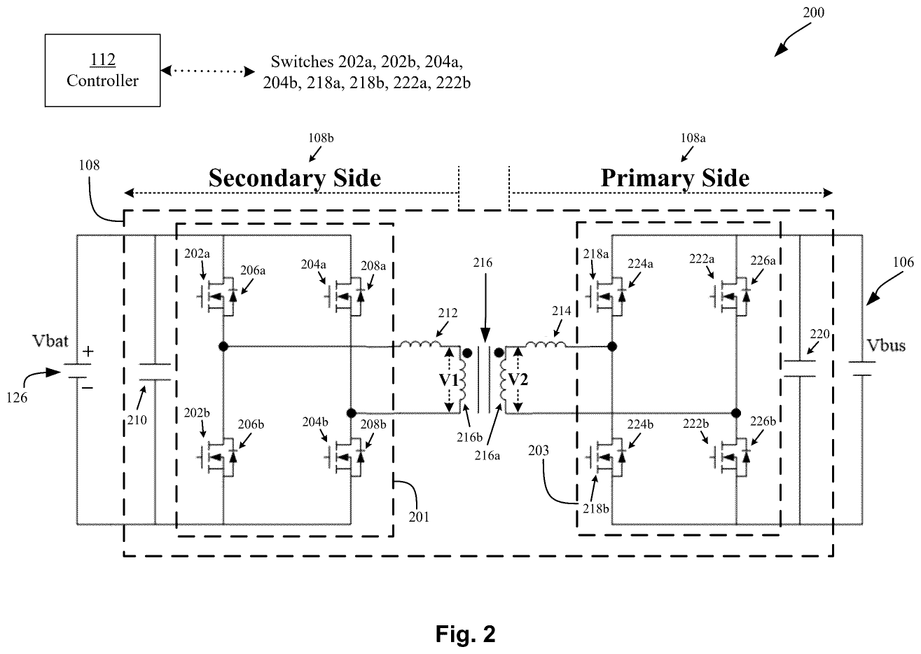

FIG. 2 illustrates a circuit diagram 200 of a DAB converter 108 according to an example. In one example, the DAB converter 108 includes a transformer 216 between a primary side 108a of the DAB converter 108 (“Primary Side”) and a secondary side 108b of the DAB converter 108 (“Secondary Side”). The transformer 216 includes a primary winding 216a and a secondary winding 216b. The primary winding 216a is coupled to the primary side 108a of the DAB converter 108. The secondary winding 216b is coupled to the secondary side 108b of the DAB converter 108. In various examples, the transformer 216 is a step-down transformer from a primary-side voltage across the primary winding 216a (“V2”) to a secondary-side voltage across the secondary winding 216b (“V1”). A turns ratio of the transformer 216 may be, for example, 1.5:1, 3:1, 5:1, or any other suitable value.

In one example, the secondary side 108b of the DAB converter 108 includes a secondary-side capacitor 210, a secondary-side H-bridge 201, and a secondary-side inductor 212. The secondary side 108b of the DAB converter 108 is coupled to the energy-storage device 126 (such as a battery). The primary side 108a of the DAB converter 108 includes a primary-side inductor 214, a primary-side H-bridge 203, and a primary-side capacitor 220. The primary side 108a of the DAB converter 108 is coupled to a DC bus 106. As noted above, the DC bus 106 may be coupled to the AC/DC converter 104 and the DC/AC inverter 114 which is coupled to an external load (not illustrated for clarity).

In one example, the secondary-side H-bridge 201 includes a first switch 202a, a second switch 204a, a third switch 202b, and a fourth switch 204b (collectively, secondary-side switches 202a, 202b, 204a, 204b). Each of the of the secondary-side switches 202a, 202b, 204a, 204b includes a first connection, a second connection, and a control connection (which may be configured to be communicatively coupled to the controller 112). The first switch 202a includes a first bypass diode 206a, the second switch 204a includes a second bypass diode 208a, the third switch 202b includes a third bypass diode 206b, and the fourth switch 204b includes a fourth bypass diode 208b (collectively, secondary-side bypass diodes 206a, 206b, 208a, 208b). Each secondary-side bypass diode 206a, 206b, 208a, 208b has a respective cathode and a respective anode. In some examples, the secondary-side bypass diodes 206a, 206b, 208a, 208b may be internal body diodes corresponding to the secondary-side switches 202a, 202b, 204a, 204b. In other examples, the secondary-side bypass diodes 206a, 206b, 208a, 208b may be separate, discrete components external to and coupled to the respective secondary-side switches 202a, 202b, 204a, 204b.

The secondary-side capacitor 210 is configured to be coupled in parallel with the energy-storage device 126 and the secondary-side H-bridge 201.

The first connection of the first switch 202a and the cathode of the first bypass diode 206a are configured to be coupled to a positive terminal of the energy-storage device 126, the first connection of the secondary-side capacitor 210, the first connection of the second switch 204a, and the cathode of the second bypass diode 208a. The second connection of the first switch 202a and the anode of the first bypass diode 206a are configured to be coupled to the first connection of the third switch 202b, the cathode of the third bypass diode 206b, and the first connection of the secondary-side inductor 212. The second connection of the secondary-side inductor 212 is coupled to the first connection of the secondary winding 216b.

The second connection of the second switch 204a is configured to be coupled to the first connection of the fourth switch 204b, the cathode of the fourth bypass diode 208b, and the second connection of the secondary winding 216b. The second connection of the third switch 202b is configured to be coupled to a negative terminal of the energy-storage device 126, the second connection of the secondary-side capacitor 210, the anode of the third bypass diode 206b, the second connection of the fourth switch 204b, and the anode of the fourth bypass diode 208b.

In this example, the primary-side H-bridge 203 includes a fifth switch 218a, a sixth switch 222a, a seventh switch 218b, and an eighth switch 222b (collectively, primary-side switches 218a, 218b, 222a, 222b). Each of the of the primary-side switches 218a, 218b, 222a, 222b includes a first connection, a second connection, and a control connection (which may be configured to be communicatively coupled to the controller 112). The fifth switch 218a includes a fifth bypass diode 224a, the sixth switch 222a includes a sixth bypass diode 226a, the seventh switch 218b includes a seventh bypass diode 224b, and the eighth switch 222b includes an eighth bypass diode 226b (collectively, primary-side bypass diodes 224a, 224b, 226a, 226b). Each primary-side bypass diode 224a, 224b, 226a, 226b has a respective cathode and a respective anode. In some examples, the primary-side bypass diodes 224a, 224b, 226a, 226b may be internal body diodes corresponding to the primary-side switches 218a, 218b, 222a, 222b. In other examples, the primary-side bypass diodes 224a, 224b, 226a, 226b may be separate, discrete components external to and coupled to the respective primary-side switches 218a, 218b, 222a, 222b.

The first connection of the fifth switch 218a and the cathode of the fifth bypass diode 224a are configured to be coupled to the first connection of the sixth switch 222a, the cathode of the sixth bypass diode 226a, the first connection of the primary-side capacitor 220, and the first connection of the DC bus 106. The second connection of the fifth switch 218a and the anode of the fifth bypass diode 224a are configured to be coupled to the first connection of the eighth switch 222b, the cathode of the eighth bypass diode 224b, and the first connection of the primary-side inductor 214. The second connection of the primary-side inductor 214 is configured to be coupled to the first connection of the primary winding 216a.

The second connection of the sixth switch 222a is configured to be coupled to the first connection of the eighth switch 222b, the cathode of the eighth bypass diode 226b, and the second connection of the primary winding 216a. The second connection of the seventh switch 218b and the anode of the seventh bypass diode 224b are configured to be coupled to the second connection of the eighth switch 222b, the anode of the eighth bypass diode 226b, the second connection of the primary-side capacitor 220, and the second connection of the DC bus 106.

In other examples, the DAB converter 108 may not include one or both of the secondary-side capacitor 210 and the primary-side capacitor 220.

One or more of the switches 202a, 202b, 204a, 204b, 218a, 218b, 222a, 222b may be constructed in a variety of manners depending upon the particular implementation. For example, one or more of the switches 202a, 202b, 204a, 204b, 218a, 218b, 222a, 222b may be implemented as a single transistor or other component capable of being selectively placed in a conducting state (which, in some examples, may be referred to as the switch being closed) or a non-conducting state (which, in some examples, may be referred to as the switch being open). A transistor, such as a field-effect transistor (FET), a bipolar-junction transistor (BJT), or others may be a suitable component. Additionally, in various examples, other elements may be used, such as microelectromechanical system (MEMS) switches, diodes, diode-connected transistors, PIN diodes, and so forth. In certain examples, multiple components or switching elements may be connected together to form any of the switches 202a, 202b, 204a, 204b, 218a, 218b, 222a, 222b.

The controller 112 may be communicatively coupled to a respective control connection of each of the switches 202a, 202b, 204a, 204b, 218a, 218b, 222a, 222b. In various examples, the controller 112 may generate PWM control signals to control each of the switches 202a, 202b, 204a, 204b, 218a, 218b, 222a, 222b.

In operation, each of the switches 202a, 202b, 204a, 204b, 218a, 218b, 222a, 222b may be closed intermittently during turn-on periods, and may be open intermittently during turn-off periods. Therefore, each of the switches 202a, 202b, 204a, 204b, 218a, 218b, 222a, 222b may have a respective duty cycle.

In various examples, the controller 112 may send PWM control signals to the switches 202a, 202b, 204a, 204b, 218a, 218b, 222a, 222b in such a way that some of the switches 202a, 202b, 204a, 204b, 218a, 218b, 222a, 222b are closed during different turn-on periods. For example, the turn-on period of the first switch 202a may be different from the turn-on period of the fourth switch 204b. Meanwhile, these two turn-on periods may have an overlap when both the first switch 202a and the fourth switch 204b are closed. This overlap may be referred to as a duty cycle overlap. Within this overlap, the second switch 204a and the third switch 202b may be open during a time interval. Some configurations of the switches 202a, 202b, 204a, 204b, 218a, 218b, 222a, 222b achieved this way during certain time intervals may allow secondary-side current pulses to be drawn from the energy-storage device 126 on the secondary side 108b and to generate primary-side current pulses on the primary side 108a. For example, during a first time interval (for example, during a positive interval), a first subset of the switches 202a, 202b, 204a, 204b, 218a, 218b, 222a, 222b may be concurrently closed such that a first secondary-side current pulse and a first primary-side current pulse flow in the DAB converter 108. During a second time interval (for example, during a negative interval), a second subset of the switches 202a, 202b, 204a, 204b, 218a, 218b, 222a, 222b may be concurrently closed such that a second secondary-side current pulse and a second primary-side current pulse flow in the DAB converter 108.

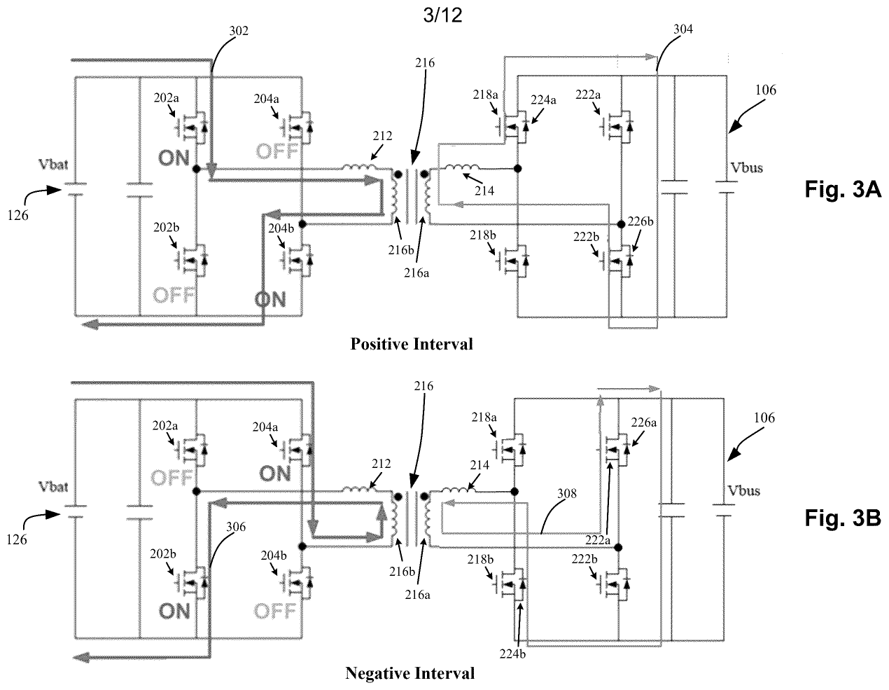

FIGS. 3A and 3B illustrate circuit diagrams of the DAB converter 108 in a PWM mode of operation during positive and negative intervals, respectively, according to an example. FIG. 3A illustrates a circuit diagram 300 of the DAB converter 108 during a positive interval of the PWM mode of operation according to an example. FIG. 3B illustrates a circuit diagram 301 of the DAB converter 108 during a negative interval of the PWM mode of operation according to an example.

In at least one example, the controller 112 implements a PWM control scheme to control the operation of the DAB converter 108. Under the PWM control scheme, the controller 112 may generate consecutive cycles of pulsed control signals to switches of the DAB converter 108. Each cycle may include a positive interval during which a first set of secondary-side and primary-side current pulses flow in the DAB converter 108 and a negative interval during which a second set of secondary-side and primary-side current pulses flow in the DAB converter 108.

Referring to FIG. 3A, in one example, during a positive interval of a PWM control cycle over the DAB converter 108, the controller 112 may control the first switch 202a and the fourth switch 204b to be in a closed and conducting state (“ON”) and control the second switch 204a and the third switch 202b to be in an open and non-conducting state (“OFF”).

Consequently, a first secondary-side current pulse 302 may pass through the secondary side 108b of the DAB converter 108 while power is drawn from the energy-storage device 126. The first secondary-side current pulse 302 passes through the first switch 202a, the fourth switch 204b, the secondary-side inductor 212, and the secondary winding 216b. Furthermore, the controller 112 may control the fifth switch 218a and the eighth switch 222b to be in a closed and conducting state and control the sixth switch 222a and the seventh switch 218b to be in an open and non-conducting state. As a result, a first primary-side current pulse 304 may pass through the primary side 108a of the DAB converter 108 while power is delivered to the DC bus 106 and the external load (not illustrated). In one example, when the fifth switch 218a and the eighth switch 222b are closed, the first primary-side current pulse 304 passes through the fifth switch 218a, the eighth switch 222b, the primary-side inductor 214, and the primary winding 216a. On the other hand, when the fifth switch 218a and the eighth switch 222b are open, the first primary-side current pulse 304 passes through the fifth bypass diode 224a, the eighth bypass diode 226b, the primary-side inductor 214, and the primary winding 216a.

Referring to FIG. 3B, in one example, during a negative interval of a PWM control cycle over the DAB converter 108, the controller 112 may control the first switch 202a and the fourth switch 204b to be in an open and non-conducting state (“OFF”) and control the second switch 204a and the third switch 202b to be in a closed and conducting state (“ON”). Consequently, a second secondary-side current pulse 306 may pass through the secondary side 108b of the DAB converter 108 while power is drawn from the energy-storage device 126. The arrowed current path 306 passes through the second switch 204a, the third switch 202b, the secondary-side inductor 212, and the secondary winding 216b. Furthermore, the controller 112 may control the fifth switch 218a and the eighth switch 222b to be in an open and non-conducting state and control the sixth switch 222a and the seventh switch 218b to be in a closed and conducting state. As a result, a second primary-side current pulse 308 may pass through the primary side 108a of the DAB converter 108 while power is delivered to the DC bus 106 and the external load (not illustrated). In one example, when the sixth switch 222a and the seventh switch 218b are closed, the second primary-side current pulse 308 passes through the sixth switch 222a, the seventh switch 218b, the primary-side inductor 214, and the secondary winding 216a. On the other hand, when the sixth switch 222a and the seventh switch 218b are open, the second primary current pulse 308 passes through the sixth bypass diode 226a, the seventh bypass diode 224b, the primary-side inductor 214, and the primary winding 216a.

In one example, when the DAB converter 108 is just turned on (for example, when the UPS 100 initially switches from the normal mode to the backup mode), the DAB converter 108 may be at a pre-charge stage of operation. At this pre-charge stage, the controller 112 controls the DAB converter 108 to balance secondary-side power on the secondary side 108b with primary-side power on the primary side 108a. The primary-side power is determined by the external load. In this process, the DAB converter 108 draws power from the energy-storage device 126 such that the output voltage of the DAB converter 108 meets the demand of the external load. The pre-charge stage may conclude when the output voltage of the DAB converter 108 meets the power demand of the external load and the power on both sides 108a, 108b of the DAB converter 108 are balanced. After the pre-charge stage, the external load may still change and the controller 112 may need to further control the DAB converter 108 to respond to that change.

In some examples, it may be desirable that a duration of the pre-charge stage is minimized without producing a significant inrush current. A significant inrush current may be difficult to avoid in a shift angle mode of the DAB converter 108. In other examples, other control circuits and methods that avoid the inrush current may fail to achieve a fast pre-charge process.

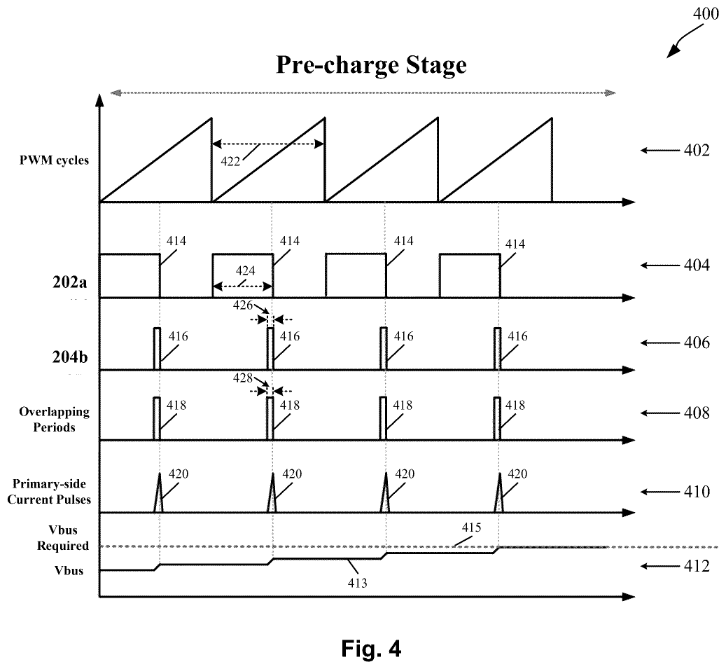

In various examples, the DAB converter 108 may operate in a duty cycle mode under the PWM scheme during the pre-charge stage in which the DC bus voltage is increased step-by-step by a series of primary-side current pulses. Examples of the PWM control signals and the resulting primary-side current pulses and increments in the DC bus voltage of the DAB converter during the pre-charge stage are described with respect to FIG. 4.

FIG. 4 illustrates a positive-interval diagram 400 of the operation of the DAB converter 108 under a PWM control scheme during the pre-charge stage according to an example. The diagram 400 includes a first graph 402, a second graph 404, a third graph 406, a fourth graph 408, a fifth graph 410, and a sixth graph 412.

In one example, the controller 112 may generate cycled (or periodic) control signals to operate the DAB converter 108 in a duty cycle mode during the pre-charge stage. The first graph 402 illustrates consecutive cycles of control signals under the PWM control scheme, in which each cycle spans a cycle period 422. In one example, the second graph 404 illustrates the control signals to the first switch 202a including a series of signal pulses 414. In this example, each signal pulse 414 keeps the first switch 202a closed and conducting for a first period 424, corresponding to a first duty cycle. Between the signal pulses 414, the first switch 202a is kept open and non-conducting.

The third graph 406 illustrates the control signals to the fourth switch 204b including another series of signal pulses 416. Each signal pulse 416 keeps the fourth switch 204b closed and conducting for a second period 426, corresponding to a second duty cycle. Between adjacent signal pulses 416, the fourth switch 204b is kept open and non-conducting. In one example, the first period 424 is longer than the second period 426, and both periods 424, 426 end at the same time.

Referring to the fourth graph 408, an overlapping period 418 indicates a time during which both the first switch 202a and the fourth switch 204b are simultaneously closed and conducting. Because the signal pulses 414 provided to the first switch 202a are high whenever the signal pulses 416 provided to the fourth switch 204b are high, the overlapping period 418 may be coextensive with the signal pulses 416 provided to the fourth switch 204b. The overlapping period 418 corresponds to the positive interval of the PWM control cycle (as discussed with respect to FIG. 3A) and a duty cycle overlap for the PWM operation of the DAB converter 108. The duration of the overlapping period 418 and the corresponding duty cycle determine the intensities of secondary-side current pulses 302 through the secondary winding 216b and primary-side current pulses 304 through the primary winding 216a, which in turn determine the time duration of the pre-charge stage. In this example, the overlapping period 418 is unchanged during the pre-charge stage.

The fifth graph 410 illustrates the primary-side current pulses 420 generated during and immediately after the overlapping periods 418, which charge the primary-side capacitor 220 and deliver power to the DC bus 106 and the external load. Each time a primary-side current pulse 420 (corresponding to the primary-side current pulse 304 in FIG. 3A) is generated and charges the primary-side capacitor 220 during an overlapping period 418 (positive interval), the output voltage across the primary-side capacitor 220 may increase during the pre-charge stage. The sixth graph 412 illustrates the cycle-by-cycle increases of the DC bus voltage 413 until the DC bus voltage 413 reaches a voltage 415 required by the external load during the pre-charge stage.

Increasing a duration of the overlapping period 418 (and the corresponding duty cycle overlap) may speed up the pre-charge process. In various examples, the controller 112 may operate the DAB converter 108 in a duty cycle mode in which the controller 112 adjusts the overlapping period 418 to control the pre-charge time of the DAB converter 108 based on the DC bus voltage and/or output power required by the external load. In one example, the controller 112 may adjust the overlapping period 418 in a duty cycle mode without breaching an upper current limit of any of the switches 202a, 202b, 204a, 204b, 218a, 218b, 222a, 222b.

In various examples, the controller 112 may also operate the DAB converter 108 in a duty cycle mode during negative intervals with respect to FIG. 3B. In one example, a second overlapping period (and the corresponding second duty cycle overlap) between the second switch 204a and the third switch 202b may be controlled in a duty cycle mode to generate a second primary-side current pulse 308 during a negative interval, which increases the DC bus voltage 413 of the same polarity as that of FIG. 3A. In certain examples, a duty cycle mode may be applied to both positive intervals and negative intervals. In one example, the overlapping period 418 (or the corresponding duty cycle overlap) during each positive interval may be the same as the second overlapping period (or the second duty cycle overlap) during each negative interval. In other examples, the overlapping period 418 (or the corresponding duty cycle overlap) during each positive interval may be different from the second overlapping period (or the second duty cycle overlap) during each negative interval.

In other examples, the overlapping period 418 of the positive interval and/or the second overlapping period of the negative interval may be increased in the duty cycle mode to further speed up the pre-charge process or to respond to an increase of the external load.

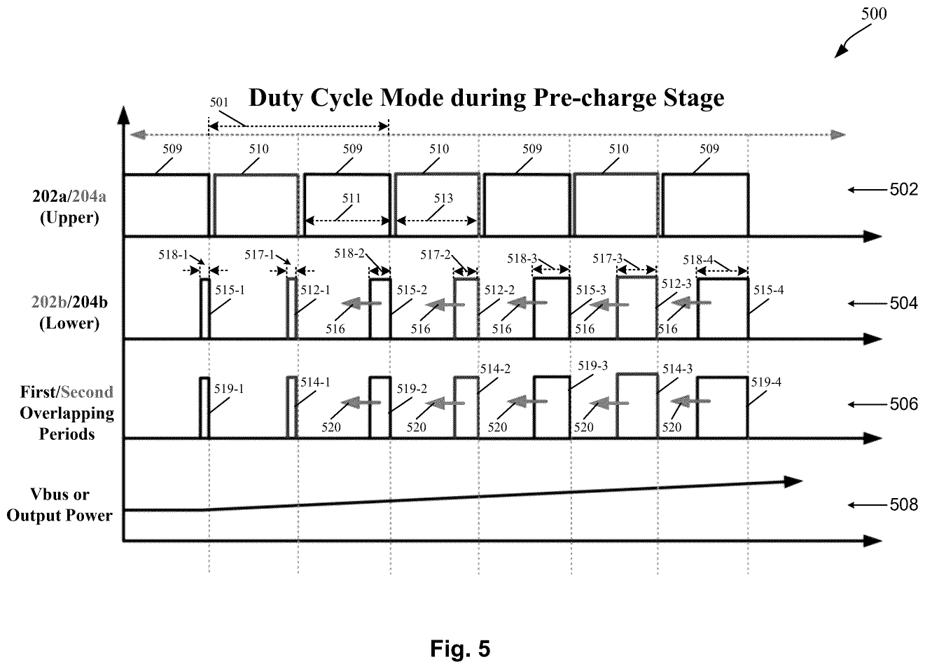

FIG. 5 illustrates a diagram 500 of a duty cycle mode of operation of the DAB converter 108 with increasing overlapping periods during the pre-charge stage according to an example. The diagram 500 includes a first graph 502, a second graph 504, a third graph 506, and a fourth graph 508. In one example, at a pre-charge stage of the DAB converter 108, a duty cycle mode of the DAB converter 108 may be implemented for each PWM cycle including both positive and negative intervals. The controller 112 may generate control signals to the primary-side H-bridge 203 to keep the primary-side switches 218a, 218b, 222a, 222b open and non-conducting throughout the duty cycle mode to prevent those switches from being damaged by primary-side current spikes.

The first graph 502 illustrates control signals (with a cycle period 501) generated by the controller 112 for the upper secondary-side switches (which may also be referred to as a first half of switches) including the first switch 202a and the second switch 204a. These control signals include a first series of signal pulses 509 to the first switch 202a and a second series of signal pulses 510 to the second switch 204a. Each pulse of the first series of signal pulses 509 keeps the first switch 202a closed and conducting for a first period 511. Each pulse of the second series of signal pulses 510 keeps the second switch 204a closed and conducting for a second period 513. The valleys between the signal pulses 509, 510 correspond to signals controlling respective switches to be open and non-conducting.

The second graph 504 illustrates the control signals generated by the controller 112 for the lower secondary-side switches (which may also be referred to as a second half of switches) including the third switch 202b and the fourth switch 204b. These control signals include a third series of signal pulses 512 (depicted as signal pulses 512-1, 512-2, 512-3, . . . ) to the third switch 202b and a fourth series of signal pulses 515 (depicted as signal pulses 515-1, 515-2, 515-3, 515-4, . . . ) to the fourth switch 204b. Each pulse of the third series of signal pulses 512 keeps the third switch 202b closed and conducting for a third period 517 (depicted as third periods 517-1, 517-2, 517-3, . . . ), corresponding to a third duty cycle. Each pulse of the fourth series of signal pulses 515 keeps the fourth switch 204b closed and conducting for a fourth period 518 (depicted as fourth periods 518-1, 518-2, 518-3, 518-4, . . . ), corresponding to a fourth duty cycle. To speed up the pre-charge process in the duty cycle mode, and/or to respond to increased power demand of the external load, the controller 112 may increase the third period 517 (or third duty cycle) and increase the fourth period 518 (or fourth duty cycle) over time. The widening of the third periods 517 and that of the fourth period 518 are indicated by the left-pointing arrows 516 in the second graph 504 such that the respective end times of each widened period remain unchanged.

In one example, the first period 511 is longer than the fourth period 518, and both periods 511, 518 end at the same time; the second period 513 is longer than the third period 517, and both periods 513, 517 end at the same time. Referring to the third graph 506, the first overlapping period 519, depicted as first overlapping periods 519-1, 519-2, 519-3, 519-4, . . . , may be coextensive with the corresponding fourth period 518 (depicted as fourth periods 518-1, 518-2, 518-3, 518-4, . . . ); a second overlapping period 514, depicted as second overlapping periods 514-1, 514-2, 514-3, . . . , may be coextensive with the third period 517 (depicted as third periods 517-1, 517-2, 517-3, . . . ). The first overlapping period 519 corresponds to a positive interval (with respect to FIG. 3A) and a first duty cycle overlap for the PWM operation of the DAB converter 108. The second overlapping period 514 corresponds to a negative interval (with respect to FIG. 3B) and a second duty cycle overlap for the PWM operation of the DAB converter 108. The first overlapping period 519 and the second overlapping period 514 widen over time as denoted by the left-pointing arrows 520.

The fourth graph 508 illustrates the increase in the DC bus voltage and/or output power resulting from the execution of the duty cycle mode in which the first duty cycle overlap is adjusted (or increased) across different positive intervals and the second duty cycle overlap is adjusted (or increased) across different negative intervals. In one example, the first duty cycle overlap may be the same as the second duty cycle overlap. In other examples, the first duty cycle overlap may be different from the second duty cycle overlap.

The increase in the output power may be in response to an initiation of the pre-charge stage and/or to an increased power demand of the external load. The external load may be increased or decreased during or after the pre-charge stage. In certain examples, in response to an increase in the demanded output power, the controller 112 may gradually increase the first duty cycle overlap and the second duty cycle overlap across at least a series of early PWM cycles such that no significant inrush currents are incurred in the DAB converter 108 at the pre-charge stage.

In some examples, in a duty cycle mode, the controller 112 may adjust the first duty cycle overlap and the second duty cycle overlap by phase-shifting the fourth period 518 relative to the first period 511 and the third period 517 relative to the second period 513, respectively, in addition to or instead of adjusting the third period 517 and the fourth period 518.

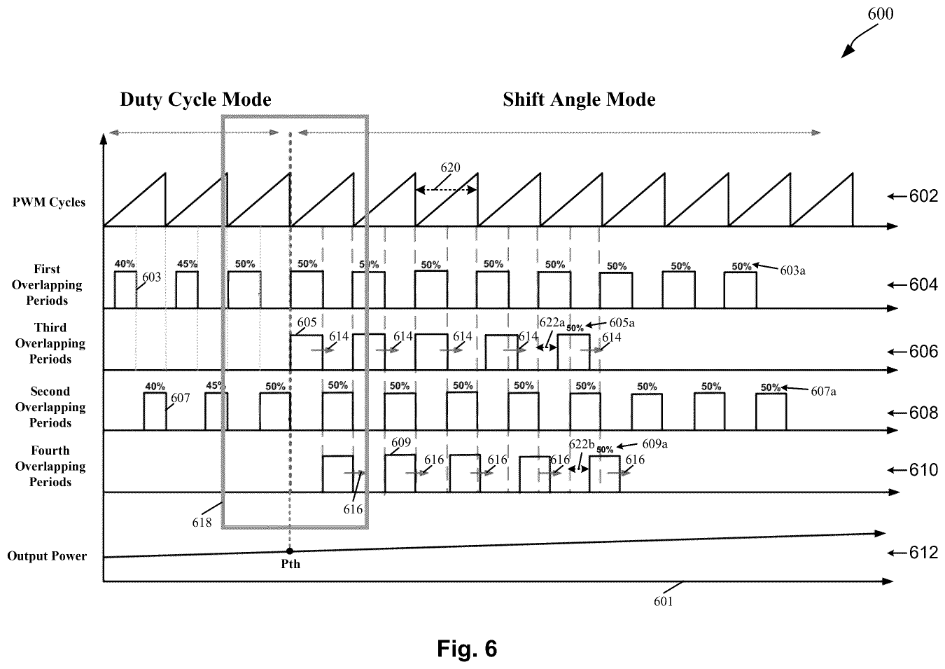

Once the first and second duty cycle overlaps are each increased to substantially 50%, if a further increase in the output power is still demanded by the external load, the controller 112 may operate the DAB converter 108 in a shift angle mode in response to the increased power demand as discussed with respect to FIG. 6.

FIG. 6 illustrates a PWM control diagram 600 including a duty cycle mode followed by a shift angle mode to operate the DAB converter 108 according to an example. In one example, the controller 112 first operates the DAB converter 108 in a duty cycle mode when the external load is below a power threshold (such as during a pre-charge stage) and then smoothly transitions the operation of the DAB converter 108 to a shift angle mode when the external load increases above the power threshold.

The diagram 600 includes a first graph 602, a second graph 604, a third graph 606, a fourth graph 608, a fifth graph 610, and a sixth graph 612. The first graph 602 illustrates consecutive PWM cycles of control signals with a cycle period 620 under a PWM control scheme. The second graph 604 illustrates the first overlapping periods 603 between the first switch 202a and the fourth switch 204b throughout the control sequence 601. When the external load is increasing but still below a power threshold (Pth in the sixth graph 612), the controller 112 operates the DAB converter 108 in a duty cycle mode in which the first overlapping period 603 and the corresponding first duty cycle overlap 603a are increased over successive positive intervals of the PWM control cycle (that is, over successive instances of the control scheme discussed with respect to FIG. 3A). In one example, the first duty cycle overlap 603a is increased from 40% to 50% in the duty cycle mode. Similarly, the fourth graph 608 illustrates the second overlapping periods 607 between the second switch 204a and the third switch 202b throughout the control sequence 601. In response to the external load increasing and being below the power threshold (Pth), the DAB converter 108 operating in the duty cycle mode increases the second overlapping period 607 and the corresponding second duty cycle overlap 607a over negative intervals. In one example, the second duty cycle overlap 607a is increased from 40% to 50% in the duty cycle mode.

In one example, the output power reaches the power threshold (Pth) when both the first duty cycle overlap 603a and the second duty cycle overlap 607a are increased to substantially 50% (maximum duty cycle overlap). Once the external load increases over the power threshold (Pth), the controller 112 automatically transitions the operation of the DAB converter 108 to a shift angle mode. This mode transition may occur smoothly within the transition region 618.

After initiating the shift angle mode, the controller 112 holds the first duty cycle overlap 603a and the second duty cycle overlap 607a at substantially 50% and begins to operate the primary-side H-bridge 203 to intermittently close (or turn on) one or more of the primary-side switches 218a, 218b, 222a, 222b. In various examples, the preceding duty cycle mode has already avoided detrimental primary-side current spikes which tend to occur before the power threshold (Pth) is reached. Therefore, closing the primary-side switches 218a, 218b, 222a, 222b in the shift angle mode may not expose the primary-side switches 218a, 218b, 222a, 222b to significant risk of current-spike damage.

In the shift angle mode, the controller 112 controls phases of the overlapping periods 603, 607 (or duty cycle overlaps 603a, 607a) of the secondary-side switches 202a, 202b, 204a, 204b relative to phases of overlapping periods (or duty cycle overlaps) of the primary-side switches 218a, 218b, 222a, 222b to further increase the output power of the DAB converter 108. In contrast to the duty cycle mode (as discussed with respect to FIG. 5) in which the controller 112 controls the overlapping periods 514, 519 (or corresponding duty cycle overlaps) within the secondary H-bridge 201 (which may be referred to as intra-bridge overlaps), the controller 112 controls other overlapping periods (or duty cycle overlaps) between the secondary-side and primary-side H-bridges 201, 203 (which may be referred to as inter-bridge overlaps) in the shift angle mode.

The third graph 606 illustrates the third overlapping periods 605 between the fifth switch 218a and the eighth switch 222b in the shift angle mode of the DAB converter 108. The third overlapping periods 605 are periods when both the fifth switch 218a and the eighth switch 222b are in a closed and conducting state and correspond to the third duty cycle overlaps 605a. In one example, the third duty cycle overlaps 605a are kept at substantially 50% in the shift angle mode. At the beginning of the shift angle mode, the third overlapping period 605 may be coextensive with the corresponding first overlapping periods 603 in the same cycle (right above). In response to further increases of the external load beyond the power threshold (Pth), in one example, the controller 112 may start to right-shift (or delay) the third overlapping period 605 relative to the corresponding first overlapping period 603 in the same cycle. The right-shifts are phase-angle shifts depicted by the right-pointing arrows 614.

Each shift causes the fifth switch 218a and the eighth switch 222b to start being concurrently closed and conducting later than when the first switch 202a and the fourth switch 204b start being concurrently closed and conducting by a first phase shift angle 622a. Each shift may allow the primary-side inductor 214 to store more energy for a period defined by the first phase shift angle 622a. The primary-side inductor 214 then outputs more power to the DC bus 106 and the external load once the fifth switch 218a and the eighth switch 222b are concurrently closed and conducting during the positive intervals. As the required output power is increased (or decreased) by the external load during later cycles, the first phase shift angle 622a is increased (or decreased) accordingly. In certain examples, the first phase shift angle 622a may be within a range of 0° to 180°.

The fifth graph 610 illustrates the fourth overlapping periods 609 between the sixth switch 222a and the seventh switch 218b in the shift angle mode of the DAB converter 108. The fourth overlapping periods 609 are periods when both the sixth switch 222a and the seventh switch 218b are closed and correspond to the fourth duty cycle overlaps 609a. In one example, the fourth duty cycle overlaps 609a are kept at substantially 50%. At the beginning of the shift angle mode, the fourth overlapping periods 609 may be coextensive with the corresponding second overlapping period 607 in the same cycle. In response to further increases of the external load beyond the power threshold (Pth), in one example, the controller 112 may start to right-shift (or delay) the fourth overlapping period 609 relative to the corresponding second overlapping period 607. The right-shifts are phase angle shifts depicted by the right-pointing arrows 616.

Each shift causes the sixth switch 222a and the seventh switch 218b to start being concurrently closed and conducting later than when the second switch 204a and the third switch 202b start being concurrently closed and conducting by a second phase shift angle 622b. Each shift may allow the primary-side inductor 214 to store more energy for a period defined by the second phase shift angle 622b. The primary-side inductor 214 then outputs more power to the DC bus 106 and the external load once the sixth switch 222a and the seventh switch 218b are concurrently closed and conducting during the negative intervals. As the required output power is increased (or decreased) by the external load during later cycles, the second phase shift angle 622b is increased (or decreased) accordingly. In certain examples, the second phase shift angle 622b may be within a range of 0° to 180°.

The phase shifts depicted by the right-pointing arrows 614, 616 are between switches of the secondary-side H-bridge 201 and switches of the primary-side H-bridge 203 and are therefore inter-bridge phase shifts. In various examples, the positive intervals and the negative intervals may include similar patterns of control signals such that the first phase shift angle 622a and the second phase shift angle 622b are the same inter-bridge phase shift angle 622 within a range of 0° to 180°.

The sixth graph 612 illustrates the continuous increase in the output power of the DAB converter 108. In one example, before the power threshold (Pth) is reached, the increase of the output power results from operating the DAB converter 108 in the duty cycle mode, in which the first duty cycle overlap 603a is increased up to substantially 50% over the positive intervals of the PWM control cycle and the second duty cycle overlap 607a is increased up to substantially 50% over the negative intervals of the PWM control cycle. After the power threshold (Pth) is reached, the further increase of the output power results from operating the DAB converter 108 in the shift angle mode, in which the third overlapping period 605 is delayed relative to the first overlapping period 603 during positive intervals, and the fourth overlapping period 609 is delayed relative to the second overlapping period 607 during negative intervals.

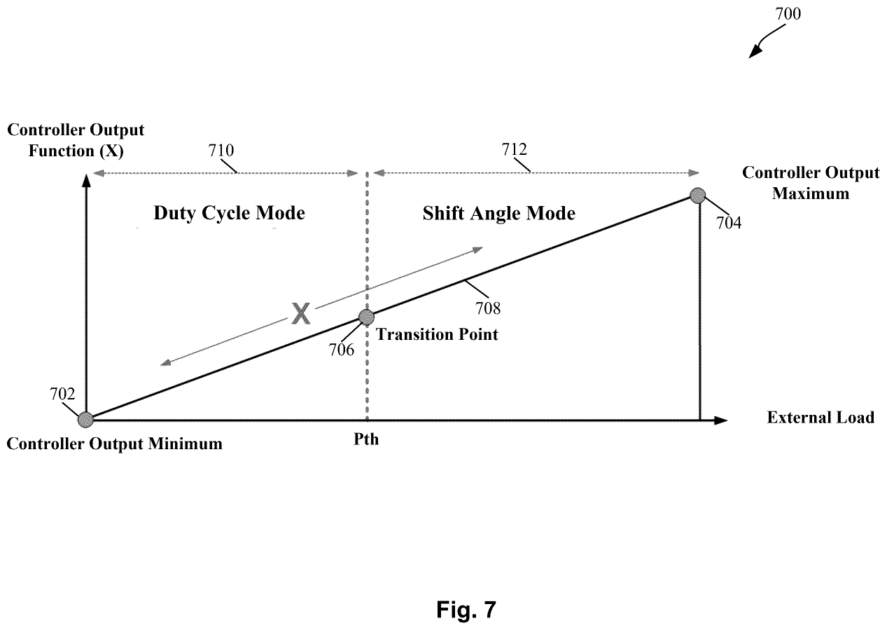

FIG. 7 illustrates a diagram 700 of a load-dependent control scheme 708 of the DAB converter 108 including a duty cycle mode 710 and a shift angle mode 712 according to an example. In various examples, the entirety of the PWM control signals of the controller 112 within a certain time duration may be defined as a controller output function (“X”) based on an algorithm. In one example, the controller 112 may be a proportional integral (PI) controller, and the controller output function (“X”) may be defined based on a mathematical calculation of the entire output control signals of the controller 112 over a PWM cycle with the external load as a variable.

The diagram 700 includes a horizontal axis of “external load” and a vertical axis of “controller output value (x).” In one example, the controller output function (“X”) may be defined to vary between a controller output minimum 702 and a controller output maximum 704 in response to changes in the external load. For example, the controller output function (“X”) may increase as the external-load power demand increases. The controller output minimum 702 may correspond to the controller signals generated by the controller 112 at the beginning of the pre-charge stage when the DAB converter 108 is initially turned on and the output power is at the lowest. The controller output minimum 702 may have a value of Xₘᵢₙ (not illustrated). The controller output maximum 704 may correspond to the controller signals generated by the controller 112 when the DAB converter 108 reaches a maximum output power capacity (for example, 100% combined duty cycle over positive and negative intervals). The controller output maximum 704 may have a value of Xₘₐₓ (not illustrated).

In various examples, the controller output function (“X”) may be defined to have a linear relationship with the external load throughout the range between the controller output minimum 702 and the controller output maximum 704. For example, the controller output function (“X”) may vary along the line of a control scheme 708 in response to changes in the external load. In various examples, a transition point 706 between the controller output minimum 702 and the controller output maximum 704 may correspond to the control signals when the external load reaches the power threshold (Pth). The transition point 706 may have a value of Xₜₕ (not illustrated) in response to an external-load power demand being equal to the power threshold (Pth).

In one example, the controller 112 may operate the DAB converter 108 in the duty cycle mode 710 in response to determining that the DAB converter 108 is operating under a light-to-medium load (that is, a load below the power threshold Pth) and may operate the DAB converter 108 in the shift angle mode 712 in response to determining that the DAB converter 108 is operating under a heavy load (that is, a load above the power threshold Pth). For example, when the required value of the controller output function (X) is below the value (Xₜₕ) of the transition point 706, the controller 112 operates the DAB converter 108 in the duty cycle mode 710. When the required value of the controller output function (X) is above the value (Xₜₕ) of the transition point 706, the controller 112 operates the DAB converter 108 in the shift angle mode 712. In one example, the transition between the duty cycle mode 710 and the shift angle mode 712 may be substantially smooth across the transition point 706 because of the linear relationship between the defined controller output function (X) and the external load within at least the vicinity (for example, the transition region 618) of the transition point 706.

In various examples, the controller output function (X) is defined as a linear function of controller register values that have a linear relationship with the external load. In one example, the controller register values may include a duty cycle register value and a shift angle register value in the output control signals of the controller 112.

For example, the duty cycle register value may be defined in a range of 0 to 500 linearly corresponding to control signals having a PWM duty cycle overlap range of 0% to 50%. In one example, when the first duty cycle overlap 603a is 25% (for example, under the duty cycle mode 710), the corresponding duty cycle register value is 250. When the first duty cycle overlap 603a is 50% (for example, under the shift angle mode 712), the corresponding duty cycle register value is 500. The shift angle register value may be defined in a range of 0 to 500 corresponding to control signals to operate the DAB converter 108 with a shift angle range of 0° to 180°. In one example, when the DAB converter 108 operates in the duty cycle mode 710, the first phase shift angle 622a is 0° and the corresponding shift angle register value is 0. When the first phase shift angle 622a is 90° (under the shift angle mode 712), the corresponding shift angle register value is 250. When the first phase shift angle 622a is 180° (at the controller output maximum 704), the corresponding shift angle register value is 500.

In one example, the controller output function (X) may be calculated based on Equation (1),

$$X = ( duty cycle register value + shift angle register value ) \times gain \qquad ( 1 )$$

in which the gain is a predetermined constant. For example, if the gain is set at 12, the duty cycle register value is 500, and the shift angle register value is 0, then the value (Xₜₕ) of the transition point 706 is calculated to be 600, that is, (500+0)×12-600. If the control signals required by the external load have a duty cycle register value of 500 (for example, because the first duty cycle overlap 603a is 50%) and a shift angle register value of 83.3 (for example, because the first phase shift angle 622a is) 30°, the controller output function (X) is calculated to have a value of 1000, that is, (500+83.3)×12=1000. Because the required value of the controller output function (X) is above Xₜₕ, the controller 112 operates the DAB converter 108 in the shift angle mode 712.

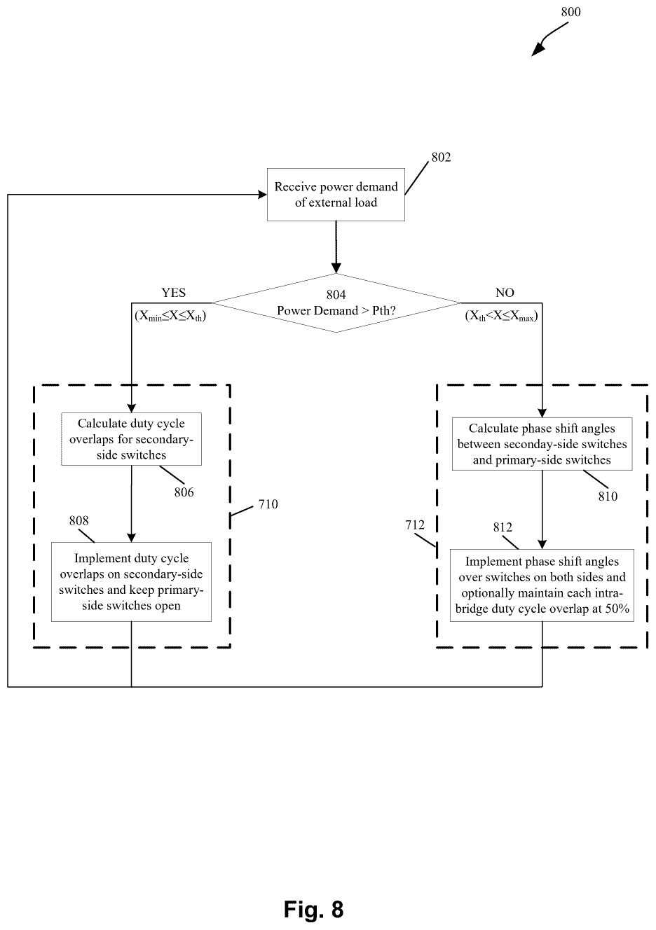

FIG. 8 illustrates a process 800 to execute the control scheme 708 of the DAB converter 108 including the duty cycle mode and the shift angle mode in response to external load variations according to an example. In at least one example, the process 800 may be executed at least in part by the controller 112 on the DAB converter 108. In some examples, the process 800 may be executed repeatedly (for example, periodically, non-periodically, continuously, and so forth) throughout the operation of the DAB converter 108.

In one example, at act 802, the controller 112 receives one or more signals indicating a power demand of the external load connected to the DAB converter 108. For example, the controller 112 may receive sensed-information signals from the sensors 124. The sensed power information may include voltage information of the external load sensed by one or more voltage sensors and/or current information sensed by one or more current sensors of the sensors 124. The controller 112 may use the sensed information to determine the power demand of the external load.

At act 804, the controller 112 determines whether the power demand of the external load exceeds the power threshold (Pth). In some examples, the controller 112 may access stored information indicative of the power threshold value. For example, the controller 112 may access the memory and/or storage 118 to determine a value of the power threshold and compare the power demand to the value of the power threshold at act 804. If the controller 112 determines that the power demand exceeds the power threshold (804 “YES”), the process 800 continues to act 806 to execute the duty cycle mode 710. Otherwise, if the controller 112 determines that the power demand does not exceed the power threshold (804 “NO”), the process 800 continues to act 810 to execute the shift angle mode 712.

In other examples, the controller 112 may convert the power demand to a controller output function (X) and compares the controller output function (X) to at least the minimum value (Xₘᵢₙ), the threshold value (Xₜₕ), and the maximum value (Xₘₐₓ) to determine the proper mode of operation of the DAB converter 108. That is, rather than (or in addition to) comparing the power demand to the power threshold (Pth), the controller 112 may convert the power demand to the controller output function (X) for comparison to one or more values or thresholds. In either example (that is, whether the controller 112 compares the power demand to the power threshold (Pth) or first converts the power demand to a controller output function (X), the one or more signals received at act 802 may be indicative of a power demand of the external load and may be indicative of being greater than or less than a threshold load.

In certain examples in which the controller 112 converts the power demand to the controller output function (X), if the controller 112 determines that the controller output function (X) is between the minimum value (Xₘᵢₙ) and the threshold value (Xₜₕ) (corresponding to the power demand exceeding the power threshold Pth), the process 800 continues to act 806 to execute the duty cycle mode 710. On the other hand, if the controller 112 determines that the controller output function (X) is between the threshold value (Xₜₕ) and the maximum value (Xₘₐₓ) (corresponding to the power demand being less than the power threshold Pth), then the process 800 continues to act 810 to execute the shift angle mode 712.

In one example, at act 806 of the duty cycle mode 710, the controller 112 calculates the required duty cycle overlaps of the secondary-side switches 202a, 202b, 204a, 204b of the DAB converter 108 during the positive and negative intervals. The calculation may be based on the external load.

At act 808 of the duty cycle mode 710, the controller 112 implements the calculated duty cycle overlaps (or the corresponding overlapping periods 514, 519) of the secondary-side switches 202a, 202b, 204a, 204b while keeping the primary-side switches 218a, 218b, 222a, 222b open and non-conducting. For example, referring to FIG. 5, if the latest first duty cycle overlap 519-3 is 40% and the calculated first duty cycle overlap 519 is 50%, the controller 112 generates a control signal pulse 515-4 of a 10% longer duration than the latest control signal pulse 515-3 to the fourth switch 204b to cause the next first duty cycle overlap 519-4 to be 50%. The controller 112 then returns to act 802.

At act 814 of the shift angle mode 712, the controller 112 calculates the phase shift angles 622a, 622b between the secondary-side switches 202a, 202b, 204a, 204b and the corresponding primary-side switches 218a, 218b, 222a, 222b based on the power demand of the external load.

At act 816 of the shift angle mode 712, the controller 112 provides control signals implementing the calculated phase-shift angles to the secondary-side switches 202a, 202b, 204a, 204b and the respective primary-side switches 218a, 218b, 222a, 222b. Optionally, the controller 112 may maintain each of the intra-bridge duty-cycle overlaps 603, 605, 607, 609 at 50%. The process 800 then returns to act 802.

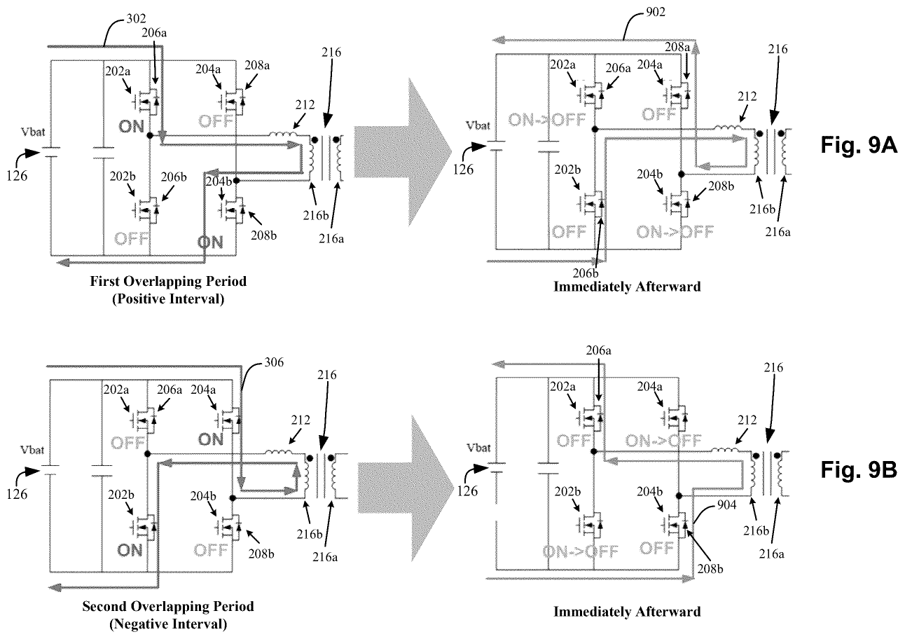

In some examples, in either the duty cycle mode 710 or the shift angle mode 712, immediately after each first overlapping period 603 (positive interval) ends, the first switch 202a and the fourth switch 204b may be turned to be open and non-conducting simultaneously while the second switch 204a and the third switch 202b remain open and non-conducting. This all-off state of the secondary-side switches 202a, 202b, 204a, 204b allows a secondary-side reverse current spike to be generated by the freewheeling secondary-side inductor 212. The secondary-side reverse current spike may damage the energy-storage device 126 and increase the turn-on losses of the second switch 204a and the third switch 202b. Similarly, another detrimental secondary-side reverse current spike may also be generated immediately after the end of each second overlapping period 607 (negative interval). FIGS. 9A and 9B illustrate circuit diagrams experiencing reverse current spikes generated on the secondary side 108b of the DAB converter 108 immediately after each first overlapping period 603 and each second overlapping period 607 according to an example.

Referring to FIG. 9A, in one example, when the first switch 202a and the fourth switch 204b are simultaneously turned from being closed and conducting to being open and non-conducting (“ON→OFF”) immediately after each first overlapping period 603, the energy stored in the secondary-side inductor 212 causes the secondary-side inductor 212 to enter a freewheeling state and generate a first secondary-side reverse current spike 902. Because the first secondary-side current spike 902 has an orientation with respect to the energy-storage device 126 opposite to that of the first secondary-side current pulse 302, the first secondary-side reverse current spike 902 may cause an unwarranted charging of the energy-storage device 126 and may damage the energy-storage device 126. Moreover, the first secondary-side reverse current spike 902 passes through the second bypass diode 208a and the third bypass diode 206b in orientations opposite to those of the upcoming second secondary-side current pulse 306 which passes through the second switch 204a and the third switch 202b. This may make it harder to reverse the current flow through the second switch 204a and the third switch 202b later (for example, during the next negative interval) and increase the turn-on losses of the second switch 204a and the third switch 202b.

Referring to FIG. 9B, in a similar example, when the second switch 204a and the third switch 202b are simultaneously turned from being closed and conducting to being open and non-conducting (“ON→OFF”) immediately after each second overlapping period 607, the energy stored in the secondary-side inductor 212 also causes the secondary-side inductor 212 to enter a freewheeling state and generate a second secondary-side reverse current spike 904. Because the second secondary-side reverse current spike 904 has an orientation with respect to the energy-storage device 126 opposite to that of the second secondary-side current pulse 306, the second secondary-side reverse current spike 904 may also cause an unwarranted charging of the energy-storage device 126 and may damage the energy-storage device 126. In addition, the second secondary-side reverse current spike 904 passes through the first bypass diode 206a and the fourth bypass diode 208b in orientations opposite to those of the upcoming first secondary-side current pulse 302 which passes through the first switch 202a and the fourth switch 204b. This may make it harder to reverse the current flow through the first switch 202a and the fourth switch 204b later (for example, during the next positive interval) and increase the turn-on losses of the first switch 202a and the fourth switch 204b.

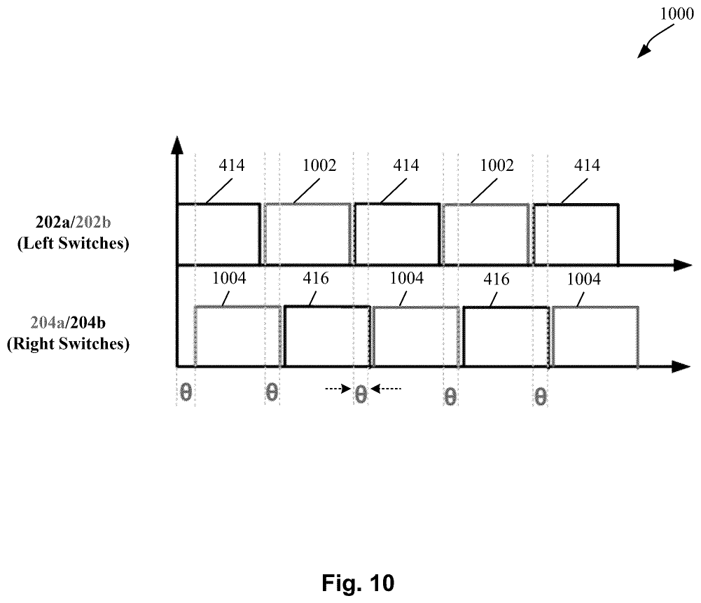

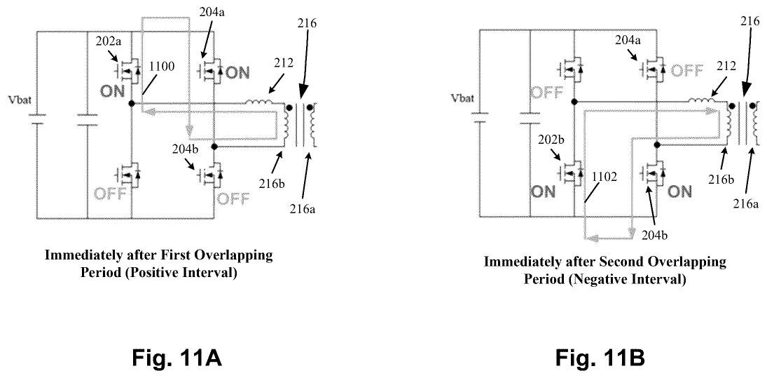

In one example, the secondary-side reverse current spikes 902, 904 in the shift angle mode 712 may be avoided by phase-shifting the control signals for the first switch 202a and/or the third switch 202b (“left switches”) relative to those of the fourth switch 204b and/or the second switch 204a (“right switches”), respectively. FIGS. 10, 11A, and 11B illustrate the shift angle mode 712 of the DAB converter 108 including implementing phase shifts of control signals between secondary-side left switches 202a, 202b (which may be referred to as a first half of switches) and secondary-side right switches 204a, 204b (which may be referred to as a second half of switches) to avoid secondary-side reverse current spikes 902, 904 according to an example.

FIG. 10 illustrates a diagram 1000 of secondary-side phase shifts between control signals to the left switches and the control signals to the right switches in the shift angle mode 712 according to an example. In one example, in addition to implementing the (inter-bridge) phase shifts at the (inter-bridge) phase shift angles 622 in the shift angle mode 712 of the DAB converter 108, the controller 112 also implements (intra-bridge) secondary-side phase shifts of the control signals to each left switch relative to those to the corresponding right switch. For example, the signal pulses 416 to the fourth switch 204b may be shifted relative to the signal pulses 414 to the first switch 202a by a secondary-side phase shift angle (“0”). The signal pulses 1004 to the second switch 204a may be shifted relative to the signal pulses 1002 to the third switch 202b by the same secondary-side phase shift angle (“0”).

Although these (intra-bridge) phase shifts may cause the first duty cycle overlap 603 and the second duty cycle overlap 607 to be less than 50% each, they eliminate the occurrence of an all-off state of the secondary-side switches 202a, 202b, 204a, 204b and therefore prevent any secondary-side reverse current spikes 902, 904 from being generated by the freewheeling secondary-side inductor 212. In one example, the secondary-side phase shift angle (“0”) may be within a range of 0° to 90°.

FIGS. 11A and 11B illustrate circuit diagrams of the implementation of the secondary-side phase shifts in the shift angle mode 712 to avoid secondary-side reverse current spikes 902, 904 according to an example. Referring to FIG. 11A, in one example, when the fourth switch 204b is turned to be open and non-conducting (“OFF”) immediately after a first overlapping period 603, the controller 112 controls the first switch 202a to remain closed and conducting (“ON”), and controls the second switch 204a to be closed and conducting (“ON”). This allows the secondary-side inductor 212 to quickly release its stored energy through a first current loop 1100 without inducing the detrimental reserve current spike 902. The first current loop 1100 passes through the first switch 202a, the second switch 204a, the secondary-side inductor 212, and the secondary winding 216b. Similarly, referring to FIG. 11B, when the second switch 204a is turned to be open and non-conducting (“OFF”) immediately after a second overlapping period 607, the controller 112 controls the third switch 202b to remain closed and conducting (“ON”), and controls the fourth switch 204b to be closed and conducting (“ON”). This also allows the secondary-side inductor 212 to quickly release its stored energy through a second arrowed current loop 1102 without inducing a detrimental secondary-side reserve current spike 904. The second current loop 1102 passes through the third switch 202b, the fourth switch 204b, the secondary-side inductor 212, and the secondary winding 216b.

In other examples, similar (intra-bridge) secondary-side phase shifts may also be implemented in a duty cycle mode 710 of the DAB converter 108, although potential secondary-side reversed current spikes therein may be lower in magnitude and less detrimental because of the lower operation power of the duty cycle mode 710 compared to that of the shift angle mode 712.

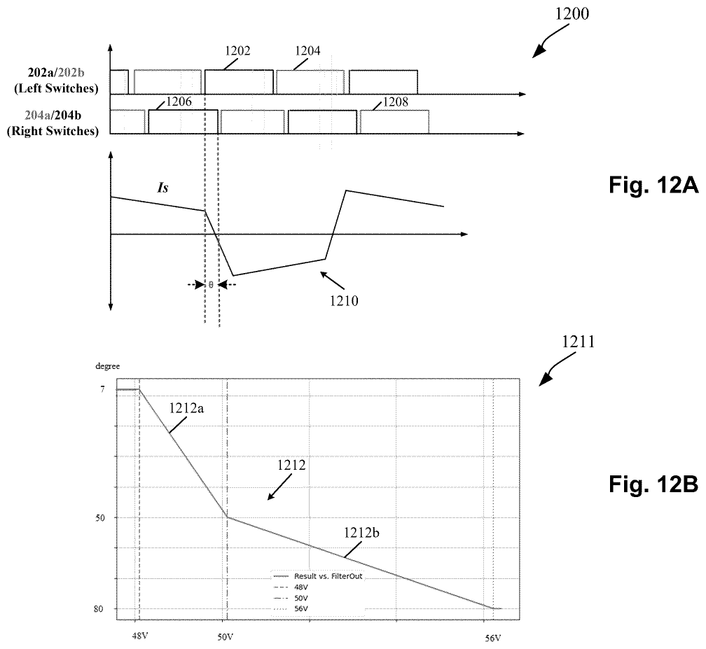

FIGS. 12A and 12B illustrate the operation of a shift angle mode 712 including implementing (intra-bridge) secondary-side phase shifts between the left switches 202a, 202b and the right switches 204a, 204b to avoid secondary-side reverse current spikes 902, 904 according to an example.

FIG. 12A illustrates a graph 1200 of control signals 1202, 1204, 1206, 1208 to the left switches 202a, 202b and right switches 204a, 204b and the corresponding secondary-side current flow 1210 (Is) of the DAB converter 108 in the shift angle mode 712 according to an example. In one example, the secondary-side current flow 1210 (Is) decreases to slightly below zero at the end of a period defined by the secondary-side phase shift angle (“θ”). As noted above, such a decrease results from a release of the stored energy in the secondary-side inductor 212 and avoids the secondary-side reverse current spike 902, 904. To estimate the required value (for example, a value φ in radians) of the secondary-side phase shift angle (θ in degrees), in one example, the secondary-side current flow (Is) at the end of the secondary-side phase shift period may be calculated based on Equation (2),

$$Is = \frac{π n V b u s - ( π - 2 ϕ ) {n}^{2} Vbat}{4 π f s L s} \qquad ( 2 )$$

where n is the transformer turn ratio, fs is the secondary-side PWM switching frequency, and Ls is the inductance of the secondary-side inductor 212. For each given DC bus voltage Vbus required by the external load, once the desired secondary-side current flow Is at the end of the period is given (such as zero or a value slightly less than zero), the secondary-side phase shift angle (θ or φ) is a function of the battery voltage (Vbat) of the energy-storage device 126 based on the formula above.

To reduce the required computing power and resources of the controller 112 in practical applications, in one example, the dependency of the secondary-side phase shift angle (θ) on the battery voltage (Vbat) may be simplified as a series of consecutive linear functions, each within a narrow range of the battery voltage (Vbat). Only the terminal points of the linear functions will be calculated by the formula above.

FIG. 11B illustrates a graph 1211 of the secondary-side phase shift angle (θ or φ) as a series of consecutive linear functions 1212 of the battery voltage (Vbat) according to an example. In one example, the dependency of the secondary-side phase shift angle (θ) on the battery voltage (Vbat) is simply approximated as a first linear segment 1212a when the battery voltage (Vbat) is between 48V to 50V and a second linear segment 1212b when the battery voltage (Vbat) is between 50V to 56V. In this example, according to the first linear segment 1212a, the secondary-side phase shift angle (θ) may linearly increase from 7° at a DC bus voltage (Vbus) of 48V to 50° at a DC bus voltage (Vbus) of 50V. According to the second linear segment 1212b, the secondary-side phase shift angle (θ) may linearly increase from 50° at a DC bus voltage (Vbus) of 50V to 80° at a DC bus voltage (Vbus) of 56V. These linear functions 1212 and values are provided as non-limiting examples only and, in other examples, different linear functions 1212 and values may be used.

Various controllers, such as the controller 112, may execute various operations discussed above. The controller 112 may also execute one or more instructions stored on one or more non-transitory computer-readable media, which the controller 112 may include, replace, and/or be coupled to, which may result in manipulated data. The non-transitory computer-readable media may include memory and/or storage. In some examples, the controller 112 may include one or more processors or other types of controllers. In one example, the controller 112 is or includes at least one processor. In one example, the controller may be a proportional-integral (PI) controller including one or more processors, such as one or more digital signal processors (DSPs). In another example, the controller 112 performs at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components. Examples of the disclosure may include a computer program product configured to execute methods, processes, and/or operations discussed above. The computer program product may be, or include, one or more controllers and/or processors configured to execute instructions to perform methods, processes, and/or operations discussed above.

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description. References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B—that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

Having thus described several aspects of at least one example, it is to be appreciated that various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

1. A battery discharge system comprising:
a first H-bridge configured to be coupled to a battery, the first H-bridge including a first plurality of switches;
a second H-bridge configured to be coupled to a load, the second H-bridge including a second plurality of switches;
a transformer coupled to the first H-bridge and the second H-bridge; and
at least one controller configured to:
receive a signal indicating that a power demand of the load is below a threshold load; and
in response to receiving the signal, generate control signals to operate the battery discharge system in a duty cycle mode in which the first plurality of switches is pulse-modulated with a duty cycle overlap adjusted based on the power demand, and the second plurality of switches is kept open.

2. The battery discharge system of claim 1, wherein the first plurality of switches includes a first half of switches and a second half of switches, and the duty cycle overlap is between a duty cycle of the first half of switches and a duty cycle of the second half of switches.

3. The battery discharge system of claim 1, wherein the at least one controller is further configured to:
receive a second signal indicating that a second power demand of the load is above the threshold load; and
in response to receiving the second signal, generate control signals to operate the battery discharge system in a shift angle mode in which the first plurality of switches and the second plurality of switches are pulse-modulated, and a phase shift angle between pulses of the first plurality of switches and pulses of the second plurality of switches is adjusted based on the second power demand.

4. The battery discharge system of claim 3, wherein the phase shift angle is between a first duty cycle overlap of the pulses of the first plurality of switches and a second duty cycle overlap of the pulses of the second plurality of switches.

5. The battery discharge system of claim 3, wherein the first H-bridge includes a first half of switches and a second half of switches, and operating the battery discharge system in the shift angle mode includes adjusting a second phase shift angle between pulses of the first half of switches and pulses of the second half of switches based on a battery voltage.

6. The battery discharge system of claim 5, wherein adjusting the second phase shift angle between the pulses of the first half of switches and the pulses of the second half of switches based on the battery voltage includes adjusting the second phase shift angle based on a linear relationship between the second phase shift angle and the battery voltage.

7. The battery discharge system of claim 3, wherein operating the battery discharge system in the shift angle mode includes setting the duty cycle overlap at substantially 50%.

8. A method of controlling a battery discharge system including a first H-bridge configured to be coupled to a battery, the first H-bridge including a first plurality of switches, a second H-bridge configured to be coupled to a load, the second H-bridge including a second plurality of switches, and a transformer coupled to the first H-bridge and the second H-bridge, the method comprising:
receiving a signal indicating that a power demand of the load is below a threshold load; and
in response to receiving the signal, operating the battery discharge system in a duty cycle mode in which the first plurality of switches is pulse-modulated with a duty cycle overlap adjusted based on the power demand, and the second plurality of switches is kept open.

9. The method of claim 8, wherein the first plurality of switches includes a first half of switches and a second half of switches; and the duty cycle overlap is between a duty cycle of the first half of switches and a duty cycle of the second half of switches.

10. The method of claim 8, further comprising:
receiving a second signal indicating that a second power demand of the load is above the threshold load; and
in response to receiving the second signal, operating the battery discharge system in a shift angle mode in which the first plurality of switches and the second plurality of switches are pulse-modulated, and a phase shift angle between pulses of the first plurality of switches and pulses of the second plurality of switches is adjusted based on the second power demand.

11. The method of claim 10, wherein the phase shift angle is between a first duty cycle overlap of the pulses of the first plurality of switches and a second duty cycle overlap of the pulses of the second plurality of switches.

12. The method of claim 10, wherein the first H-bridge includes a first half of switches and a second half of switches, and operating the battery discharge system in the shift angle mode includes adjusting a second phase shift angle between pulses of the first half of switches and pulses of the second half of switches based on a battery voltage.

13. The method of claim 12, wherein adjusting the second phase shift angle between the pulses of the first half of switches and the pulses of the second half of switches based on the battery voltage includes adjusting the second phase shift angle based on a linear relationship between the second phase shift angle and the battery voltage.

14. The method of claim 10, wherein operating the battery discharge system in the shift angle mode includes setting the duty cycle overlap at substantially 50%.

15. At least one non-transitory computer-readable medium storing thereon sequences of computer-executable instructions for controlling a battery discharge system including a first H-bridge configured to be coupled to a battery, the first H-bridge including a first plurality of switches, a second H-bridge configured to be coupled to a load, the second H-bridge including a second plurality of switches, and a transformer coupled to the first H-bridge and the second H-bridge, the sequences of computer-executable instructions include instructions that instruct at least one processor to at least:
receive a signal indicating that a power demand of the load is below a threshold load; and
in response to receiving the signal, operate the battery discharge system in a duty cycle mode in which the first plurality of switches is pulse-modulated with a duty cycle overlap adjusted based on the power demand, and the second plurality of switches is kept open.

16. The at least one non-transitory computer-readable medium of claim 15, wherein the first plurality of switches includes a first half of switches and a second half of switches, and the duty cycle overlap is between a duty cycle of the first half of switches and a duty cycle of the second half of switches.

17. The at least one non-transitory computer-readable medium of claim 15, wherein the instructions further instruct the at least one processor to:
receive a second signal indicating that a second power demand of the load is above the threshold load; and
in response to receiving the second signal, operate the battery discharge system in a shift angle mode in which the first plurality of switches and the second plurality of switches are pulse-modulated, and a phase shift angle between pulses of the first plurality of switches and pulses of the second plurality of switches is adjusted based on the second power demand.

18. The at least one non-transitory computer-readable medium of claim 17, wherein the phase shift angle is between a first duty cycle overlap of the pulses of the first plurality of switches and a second duty cycle overlap of the pulses of the second plurality of switches.

19. The at least one non-transitory computer-readable medium of claim 17, wherein the first H-bridge includes a first half of switches and a second half of switches, and operating the battery discharge system in the shift angle mode includes adjusting a second phase shift angle between pulses of the first half of switches and pulses of the second half of switches based on a battery voltage.

20. The at least one non-transitory computer-readable medium of claim 19, wherein adjusting the second phase shift angle between the pulses of the first half of switches and the pulses of the second half of switches based on the battery voltage includes adjusting the second phase shift angle based on a linear relationship between the second phase shift angle and the battery voltage.
